(19) United States
(12) Patent Application Publication
(10) Pub. No.: US 2014/0007520 A1
(43) Pub. Date: Jan. 9, 2014

(54) CUBIC BORON NITRIDE CRYSTAL, BODIES COMPRISING SAME AND TOOLS COMPRISING SAME

(71) Applicant: Karolina Hannersjö, Robertsfors (SE)

(72) Inventor: Karolina Hannersjö, Robertsfors (SE)

(73) Assignee: Element Six Limited, County Clare (IE)

(21) Appl. No.: 14/005,918

(22) PCT Filed: Mar. 28, 2012
(86) PCT No.: PCT/EP2012/055494

§ 371 Date: Sep. 18, 2013

Related U.S. Application Data
(60) Provisional application No. 61/469,546, filed on Mar. 30, 2011.

(30) Foreign Application Priority Data
Mar. 30, 2011 (GB) 1105381.6

(51) Int. Cl. C09K 3/14

(52) U.S. Cl. CPC C09K 3/1409
USPC 51/309; 51/307

(57) ABSTRACT

A cubic boron nitride (cBN) crystal or plurality of crystals containing a chloride salt compound including an alkali metal or an alkali earth metal. For example, the chloride salt compound may be selected from potassium chloride, magnesium chloride, lithium chloride, calcium chloride or sodium chloride. The crystal or crystals may have a relatively rough surface texture.

This disclosure relates generally to cubic boron nitride crystals, bodies comprising same, particularly but not exclusively bodies comprising polycrystalline cubic boron nitride material comprising same, and tools comprising same, particularly but not exclusively grinding tools.

U.S. Pat. No. 3,881,890 discloses cubic boron nitride crystals in which phosphorus is incorporated. The use of ammonium chloride as a mineraliser in the process of synthesising cBN material is also disclosed in combination with phosphorus-containing compounds and other aspects.

Sulzhenko and Sokolov (Sulzhenko, A. A. and A. N. Sokolov (1999) “The effect of chemical composition of a crystallisation medium on stoichiometry of cBN crystals”, Journal of Superhard Materials, vol. 21 no. 4, pp. 36 to 39) disclose that the growth of cBN crystals in the presence of NH₄Cl (ammonium chloride) resulted in strong crystals having a high degree of perfection of the crystal structure, with perfect crystal habit and mirror faces with no visible inclusions.

There is a need for cBN crystals for use in grinding metal bodies, capable of providing ground surfaces with enhanced smoothness.

Viewed from a first aspect there is provided a cubic boron nitride (cBN) crystal or a plurality of cBN crystals, the or each crystal including a chloride salt compound such as potassium chloride (KCl), magnesium chloride (MgCl₂), lithium chloride (LiCl), calcium chloride (CaCl₂), sodium chloride (NaCl) and or ammonium chloride NH₄Cl present as or in inclusions or as interstitial or substitutional impurities in the cBN lattice. A plurality of the crystals can be provided. In some examples, the chloride salt compound may be selected from potassium chloride (KCl) or magnesium chloride (MgCl₂). In one example, the cBN crystal may be substantially free of barium chloride (BaCl₂).

In some examples, the cBN crystal may include alpha-B₂O₃ or beta-B₂O₃ present as or in inclusions or as interstitial or substitutional impurities in the cBN lattice.

In some examples, the cBN crystal may be substantially free of titanium compounds such as TiH₂, TiO₂, TiB₂, TiC, TiN.

The cBN crystal or crystals may fall within a U.S. Mesh size band of 30/50 or 35/40. In some examples, the cBN crystal or a plurality of the cBN crystals may have a number of inclusions or a mean number of inclusions, respectively, of at least about 5 or and at most about 20. In some example crystals, at least about half of the crystals may be elongate, having an aspect ratio of at least about 1.5 or at least about 2.

The cBN crystal or crystals may have inclusions comprising a chloride salt compound such as potassium chloride (KCl), magnesium chloride (MgCl₂), lithium chloride (LiCl), calcium chloride (CaCl₂), sodium chloride (NaCl) and or ammonium chloride NH₄Cl. A plurality of the crystals can be provided. In some examples, the chloride salt compound may be selected from potassium chloride (KCl) or magnesium chloride (MgCl₂). In one example, the inclusions may be substantially free of barium chloride (BaCl₂). In some examples, the inclusions may include alpha-B₂O₃ or beta-B₂O₃ compounds. In some examples, the inclusions may be substantially free of titanium compounds such as TiH₂, TiO₂, TiB₂, TiC, TiN.

The cBN crystal or crystals may have inclusions and the volume of each inclusion or the mean volume of the inclusions may be at least about 300 cubic microns and at most about 60,000 cubic microns. A plurality of cBN crystals may have inclusions and the mean volume of the inclusions may be at least about 300 cubic microns and at most about 20,000 cubic microns. In some example cBN crystals or plurality of crystals, at least half of the inclusions may have a volume of at most about 10,000 cubic microns or at most about 8,000 cubic microns.

The chloride salt may be present as highly dispersed, fine-grained inclusions having a mean size of at most about 4 microns, at most about 2 micron, at most about 1 micron or at most about 500 nm. The chloride salt may be selected from potassium chloride, lithium chloride, magnesium chloride, sodium chloride, calcium chloride or beryllium chloride. The content of alkali or alkali earth metal in the cBN crystals may be at least about 10 parts per million (ppm) or at least about 100 ppm, and or at most about 100,000 ppm, at most about 10,000 ppm or at most about 1,000 ppm.

The cBN crystal or crystals may have inclusions and the density of each inclusion or the mean density of the inclusions may be at least about 0.5 gram per cubic centimeter or at least about 1 gram per cubic centimeter and at most about 3 grams per cubic centimeter or at most about 2.5 grams per cubic centimeter.

The cBN crystals may have crystal habit corresponding to a cubo-octahedral index of at least 5 (i.e. the crystals are more octahedral than cubic) and a tetrahedral index TI of at most 2 (i.e. the crystals are more tetrahedral than cubic or octahedral).

The surfaces of the cBN crystals may have a rough, etched appearance and have relatively few smooth or “shiny” surfaces. The cBN crystal may have surface roughness such that each crystal has at least about 80 surface faces per square millimeter of the crystal surface, each face having an area of at least about 500 square microns.

The cBN crystal may fall within a U.S. Mesh size band of 30/50 or 35/40. The surface roughness of the cBN crystal may be such that each crystal has at least about 80 or at least about 100 surface faces per square millimeter (mm²) of the crystal surface, each face having an area of at least about 500 square microns (the number of surface faces and respective surface areas tend to be proportional to the crystal size). The surface roughness of the cBN crystal may be such that each crystal has at most about 180 or at most about 160 surface faces per square millimeter (mm²) of surface area of the crystal, each face having an area of at most about 500 square microns.

The cBN crystal or crystals may have a relative abundance of surface faces in combination with high strength. The strength in terms of friability of a plurality of cBN crystals according to this disclosure may be at least about 50 per cent, at least about 60 per cent or at least about 70 per cent. Crystals having a size of at most in the US mesh range 50/60 may tend to have friability strength of at least about 60 per cent. The crystals may have relatively high thermal stability.

Example cBN crystals may include stochiometric excess of nitrogen (N) and have yellow or amber colour.

Example cBN crystals may have the aspect of high thermal stability (i.e. high strength even after heat treatment).

Example cBN crystals may have size in the range of at least about 100 microns, at least about 300 microns or at least about 700 microns. The cBN crystals may have mean size corresponding to 60/70 US Mesh, 50/60 US Mesh, 45/50 US Mesh or 35/40 US Mesh.

Viewed from a second aspect there is provided a method of making a cBN crystal, the method including combining a source of boron nitride, such as hexagonal boron nitride (hBN), a catalyst material such as lithium (Li) for promoting the growth of cBN crystals and a source of chlorine such as ammonium chloride (NH₄Cl) in a reaction volume, and subjecting the reaction volume to a pressure and temperature in the presence of a source of an alkali metal such as K, Na or an alkaline earth metal such as Mg, Be, Ca or Sr, at which pressure and temperature cBN is more thermally stable than hBN, to form a cBN crystal. The cBN crystal may be provided with a coating such as a nickel-containing coating by means of electroplating.

Disclosed cBN crystals may have the aspect that they tend to exhibit wear in use by micro-fracture as a major wear mode. In other words, the crystals may tend to wear by microscopically small pieces becoming detached from the crystals at the surface, rather than principally by cleaving through the crystal along crystallographic planes. This may have the effect of maintaining a rough crystal surface and reducing the size fractured pieces of the crystal in use, which is likely to prolong the overall life of the abrasive tool in which the material is used. This may be expected to result in a smoother surface of the body being ground, since the size of a crystal is unlikely to change suddenly by major breakage. While wishing not to be bound by a particular theory, a tendency to micro-fracture may be promoted by the dispersion within the crystals of very small inclusions. The roughness of the surface of the crystals may also be expected to promote micro-fracture.

Viewed from a third aspect there is provided a body comprising polycrystalline cBN material (PCBN) comprising a plurality of cBN crystals according to this disclosure.

As used herein, PCBN material comprises grains of cubic boron nitride (cBN) within a matrix comprising metal or ceramic material. For example, PCBN material may comprise at least about 40 volume per cent or at least about 60 volume per cent cBN grains dispersed in a binder matrix material comprising a Ti-containing compound, such as titanium carbonitride and/or an Al-containing compound, such as aluminium nitride, and/or compounds containing metal such as Co and/or W. Some versions (or “grades”) of PCBN material may comprise at least about 80 volume per cent or even at least about 85 volume per cent cBN grains. PCBN may be made by sintering an aggregation of cBN grains with ceramic or metal material, or precursor material for ceramic or metal at an ultra-high pressure and high temperature. For example, the pressure may be at least about 4 GPa and the temperature may be at least about 1,000 degrees centigrade.

Viewed from a fourth aspect there is provided a tool comprising a plurality of cBN crystals according to this disclosure. For example, the tool may comprise a grinding wheel, cutting tool, saw blade or bead for a wire saw. A grinding wheel may comprise electroplated-, resin-, metal- or vitrified-bonded cBN crystals.

Disclosed cBN crystals are expected to be suitable for use in electroplated grinding tools.

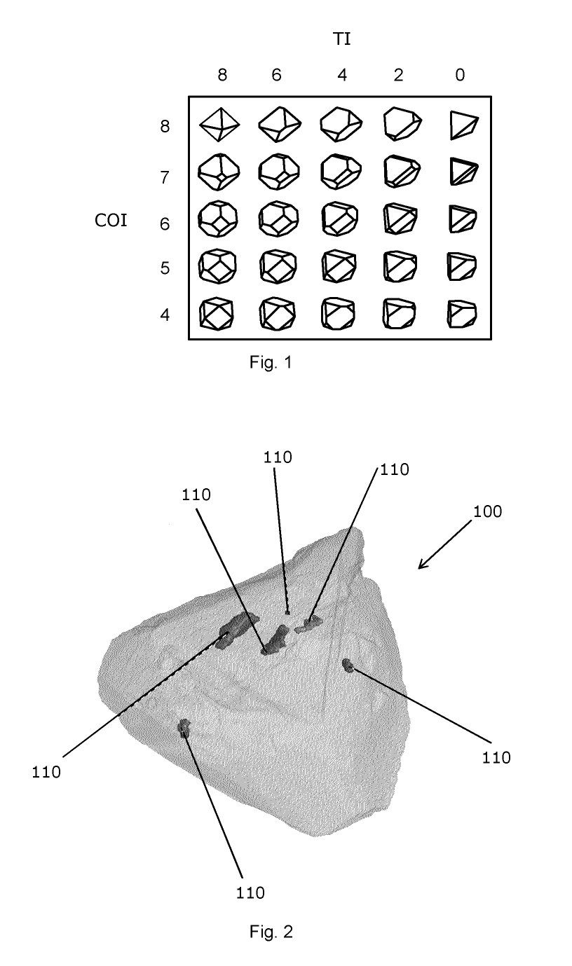

FIG. 1 shows various principal crystal habits of cBN crystals in terms of cubo-octahedral index COI and tetrahedral index TI;

FIG. 2 shows a computed X-ray tomography image of an example cBN crystal;

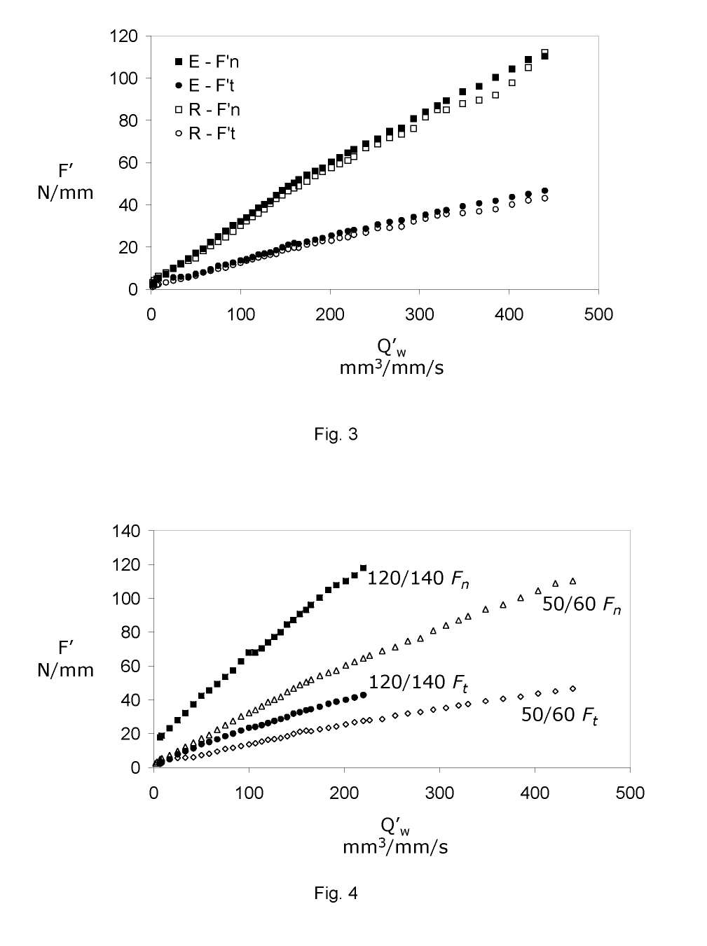

FIG. 3 shows the variation of the specific normal and tangential grinding forces F′ₙ, F′ₜ generated by example cBN grit E and a reference cBN grit product R, both in US Mesh size range 50/60, as functions of specific material removal rate Q′_{w};

FIG. 4 shows the variation of the specific normal grinding forces F′ₙ and specific tangential grinding forces F′ₜ generated by example cBN grit in US mesh size ranges 50/60 and 120/140 as functions of specific material removal rate Q′_{w};

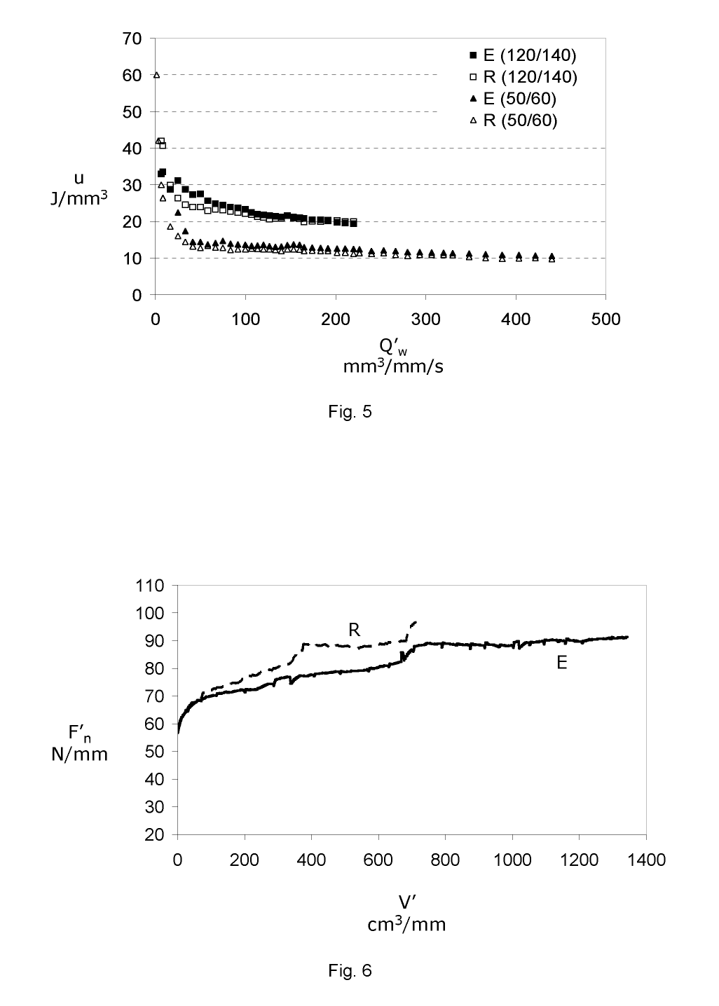

FIG. 5 shows the variation of the specific grinding energy u′ for example cBN grit E and reference cBN grit R, both in US mesh sizes 50/60 and 120/140, as functions of specific material removal rate Q′_{w};

FIG. 6 shows the specific normal grinding force F′ₙ logged during a tool-life test of example cBN grit E and reference cBN grit R, both in the 120/140 US Mesh size range, as functions of specific volume V′ of workpiece material ground;

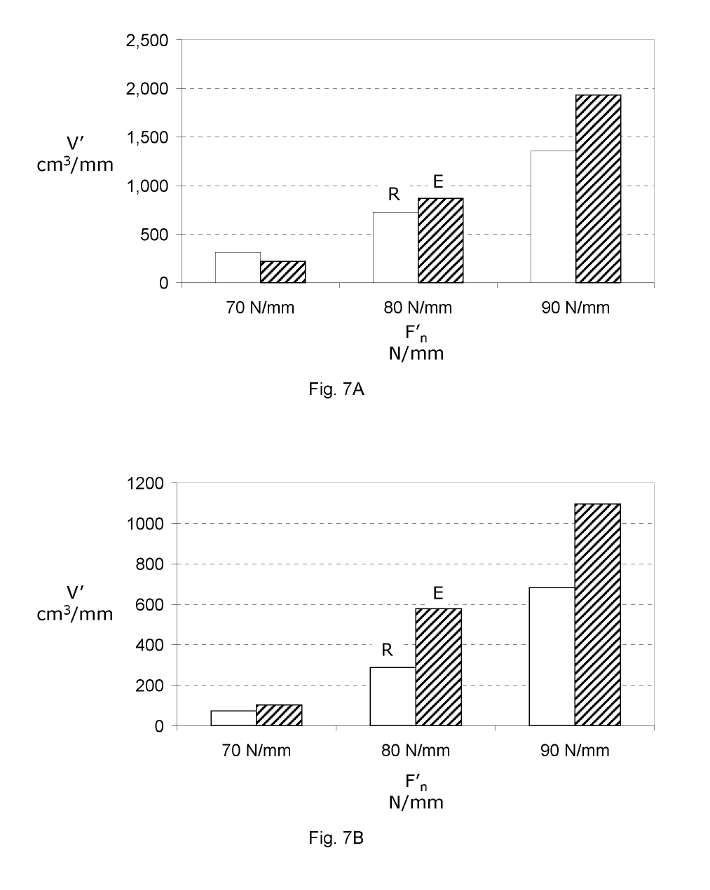

FIG. 7A shows comparative specific volumes V′ removed by the grinding wheels comprising example cBN grit E and reference cBN grit R in the US Mesh size range 50/60, corresponding to specific normal grinding forces F′ₙ of 70 N/mm, 80 N/mm and 90 N/mm. FIG. 7B shows this data in the case of the grit in US Mesh size range 120/140;

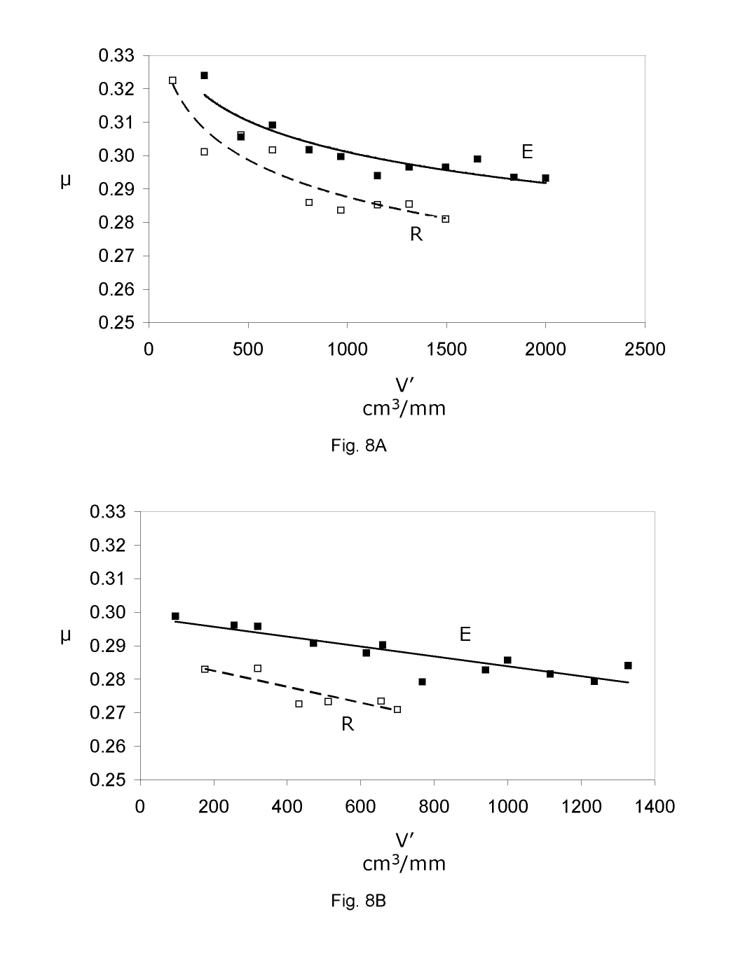

FIG. 8A shows comparative force ratios p for the wheels comprising example cBN grit E and reference cBN grit R in the US Mesh size range 50/60, as functions of specific volumes V′ of workpiece material removed. FIG. 8B shows this data in the case of the grit in US Mesh size range 120/140;

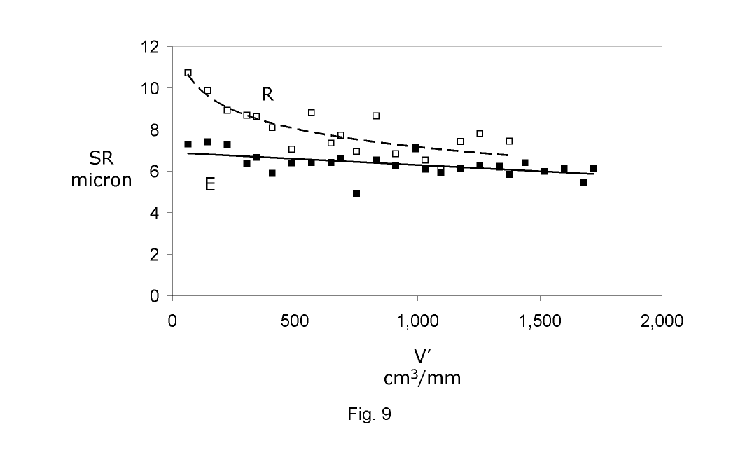

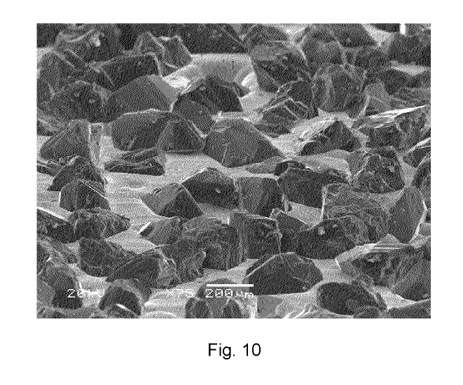

FIG. 9 shows the surface roughness SR perpendicular to the grinding direction generated during the tool-life test by example cBN grit E and reference cBN grit R in the US Mesh size range 50/60; and

FIG. 10 shows a scanning electron micrographic image (SEM) of the surface of the grinding wheel comprising example cBN grit in the 50/60 US Mesh size range after a window-of-operation test.

With reference to FIG. 1, example cBN crystals may have crystal habit corresponding to a cubo-octahedral index COI of at least 5 (i.e. the crystals are more octahedral than cubic) and a tetrahedral index TI of at most 2 (i.e. the crystals are more tetrahedral than cubic or octahedral). Example cBN crystals may have the appearance of being relatively sharp and angular. The surfaces of the cBN crystals may have a rough, etched appearance and have relatively few smooth or “shiny” surfaces.

In one version of an example method of making cBN crystals, the ammonium chloride in the reaction volume may be present in the amount of at least about 0.5 weight percent or at least about 1 weight percent and at most about 6 weight percent or at most about 4 weight percent of the combined weight of the source of boron nitride and the catalyst material and any other additives, such as may promote the formation of cBN crystals or modify their microstructure or growth.

While wishing not to be bound by a particular theory, the presence of ammonium may have the effect of helping to increase the pressure in the reaction volume when it is heated. This may have the effect of promoting the growth of cBN and the formation of relatively large cBN crystals

In one example, the method may include providing cBN crystals having relatively smooth surfaces and treating the crystals to roughen the surface.

Surfaces of cBN crystals can have relatively complex shapes and textures and generally comprise a plurality of distinct faces or facets, reflecting the underlying crystal structure and symmetry. A euhedral crystal will likely have relatively few facets and a regular crystal habit, whereas non-euhedral crystals may have a relatively complex arrangement of a relatively large number of surface faces or facets. The surface roughness of a cBN crystal within a given size band may be expressed in terms of the number of surface faces having an area of at least some threshold value, such as 500 square microns, per square millimeter of the crystal surface. Surface faces will be evident from an inspection of a magnified image of the crystal, which may be aided by image processing methods. In general, the higher the number of surface faces of at least the threshold area for a crystal of a given size, the rougher the surface may be said to be. In order to make this metric for surface roughness substantially independent of the size of the crystals, the number of surface faces having an area of at least the threshold value is divided by the total surface area of the crystal. In general, when measuring the mean surface roughness of a plurality of crystals, at least 3 crystals should be inspected.

A computed tomography (CT) scanning apparatus may be used to obtain a three dimensional image of the crystals, which is likely to aid the measurement of surface roughness. CT scanners use digital geometric processing and X-rays to compile three dimensional images of bodies such as crystals, based on a large series of two dimensional X-ray images taken around a single axis of rotation about the body. For example, a Metrotom 800™ CT scanner apparatus available from Carl Zeiss Industrial Metrology™ can be used. Image analysis software may be used to analyse the images obtained using the CT scanner apparatus by, for example, calculating a detailed finite element representation of the surface of each crystal. The volume and area of each crystal, as well as the area of each face on the surface can be calculated from the representation. Consequently, the number of faces having an area of at least some threshold value can be calculated. Dividing this number by the overall surface area of the crystal will yield a metric of surface roughness that is substantially independent of the size of the crystal. Inclusions in cBN crystals can also be studied using CT scanner apparatus and image analysis software.

With reference to FIG. 2, an example cBN crystal 100 contains six inclusions 110, the smallest inclusion having a volume of about 500 cubic microns and the largest having a volume of about 40,000 cubic microns. The densities of the inclusions are in the range from about 1.2 grams per cubic centimeter to about 2.6 grams per cubic centimeter.

The strength of cBN crystals can be expressed in terms of their friability, which can be measured by selecting a plurality of crystals having a size within a particular size range, subjecting the crystals to multiple impacts and then measuring the percentage of crystals that remain within the size range after the impact treatment. The crystals may be selected by sieving a plurality of crystals between sieves corresponding to particular US Mesh sizes and the friability may be expressed in terms of the weight percentage of the crystals that remain within those sieves after the impact treatment. The multiple impacts are achieved by placing a particular mass of crystals into a vessel with a metal ball having a particular mass, and mechanically shaking the vessel for a particular number of cycles at particular frequency and amplitude. A figure of merit for the thermal stability of crystals may be measured by measuring the friability of a sample of crystals after the crystals have been heat treated in an inert atmosphere at an elevated temperature such as 1,100 degrees centigrade for a period of time.

The cBN grit may be tested in a grinding application by electroplating a particular quantity of crystals as a single layer onto a carrier wheel to form an electroplated grinding wheel, and using the grinding wheel to grind a metal workpiece, as described in more detail by Tuffy and O'Sullivan (Tuffy, K. and M. O'Sullivan (2006) “Abrasive machining of ductile iron with cBN”, Industrial Diamond Review, Vol. 1, pages 33-37). Two types of grinding test may be performed on the crystals (also referred to as grit) In a short “window-of-operation” test a grinding wheel is run across a wide range of specific material removal rates, up to 450 mm³/mm/s where possible, to investigate differences in the grinding forces generated and grinding efficiency. The grinding conditions at the upper end of this window-of-operation test could be considered to be in the high efficiency deep grinding (HEDG) region. The normal and tangential grinding forces are monitored during the test. In a tool life test, a workpiece is ground at a constant moderate material removal rate until a designated end-of-life criterion is reached. As used herein, the tool-life is defined as the specific volume of material ground before the specific normal grinding force exceeds 90 N/mm. An increase in the grinding force with an increase in the volume of workpiece ground may be expected due to the progressive wear of the abrasive particles increasing the actual contact area and the number of active grains.

When considering the results of the two types of grinding tests described above, it is relevant to bear in mind the difference in the total volume of workpiece ground in the tests. In the present disclosure, about 133 cm³ of cast iron is ground during each window-of-operation test whereas up to 1,880 cm³ or up to 9,850 cm³ is removed during each of the tool-life tests.

A non-limiting example is described in more detail below to illustrate the disclosure.

A reaction volume was prepared by blending 88 weight per cent hBN powder, 10 weight percent lithium boron nitride (Li₂BN₃) powder and 2 weight percent NH₄Cl powder. Small seed crystals of cBN were also introduced. A source of potassium was also introduced. The reaction volume was subjected to a pressure of about 5.5 GPa and a temperature of about 1,300 degrees centigrade for several minutes, following which the reaction volume was treated to release a plurality of grown cBN crystals. The crystals had a mean size in the range of 30/60 US Mesh. The crystals had relatively rough surfaces with an “etched” appearance.

Four of the cBN crystals were selected at random and studies in detail by means of computed X-ray tomography (CT scan), using a Metrotom 800™ CT scanner apparatus available from Carl Zeiss Industrial Metrology™. Table 1 below shows the volumes and densities of the inclusions within each of the four cBN crystals.

There was evidence from the CT analysis that at least some of the inclusions contained Li₃N, NH₄Cl, Li₃BN₂, C, hBN, alpha-B₂O₃, elemental Li, elemental K, KCl and LiCl. There was some evidence from the CT analysis that at least some of the inclusions contained CaCl₂, NaCl, MgCl₂ and beta-B₂O₃.

TABLE 1

| | Crystal 1 | | Crystal 2 | | Crystal 3 | | Crystal 4 | |
|---|---|---|---|---|---|---|---|---|
| | Volume, | | Volume, | | Volume, | | Volume, | |
| Incl. | cubic | Density, | cubic | Density, | cubic | Density, | cubic | Density, |
| No. | micron | g/cm³ | micron | g/cm³ | micron | g/cm³ | micron | g/cm³ |
| 1 | 19,057 | 1.3 | 6,352 | 1.4 | 9,013 | 1.9 | 35,281 | 1.5 |
| 2 | 28,414 | 1.2 | 2,060 | 1.7 | 1,459 | 2.0 | 37,427 | 1.2 |
| 3 | 8,327 | 1.6 | 10,215 | 1.7 | 1,116 | 1.8 | 9,357 | 2.3 |
| 4 | 50,647 | 1.6 | 2,575 | 1.7 | 4,120 | 2.1 | 13,735 | 2.4 |
| 5 | 5,751 | 2.2 | 1,116 | 1.9 | 773 | 2.7 | 515 | 2.6 |
| 6 | 8,327 | 2.3 | 7,726 | 2.3 | 343 | 2.8 | 4,464 | 2.2 |
| 7 | 3,777 | 2.3 | 858 | 2.8 | | | | |
| 8 | 1,202 | 2.3 | 687 | 2.3 | | | | |
| 9 | 3,004 | 2.1 | 1,288 | 2.7 | | | | |
| 10 | 4,807 | 2.1 | | | | | | |
| 11 | 944 | 2.5 | | | | | | |
| 12 | 2,060 | 2.6 | | | | | | |
| 13 | 4,292 | 2.5 | | | | | | |
| 14 | 773 | 2.8 | | | | | | |
| 15 | 858 | 2.8 | | | | | | |
| 16 | 687 | 2.8 | | | | | | |

The example cBN grit was divided into twelve US Mesh size bands by means of sieving and a sample of crystals from each band was subjected to friability strength tests. A second sample from each size band was subjected to heat treatment at 1,100 degrees centigrade before being subjected to a friability strength test. The results of the friability tests on both sets of samples are shown in table 2 below. The mass of the steel ball and the number of cycles used for in the friability test are also shown in the table. The friability strength of the reference crystals in certain US Mesh size bands was measured and also shown in table 2.

The cBN crystals were processed to provide two populations having respective size range of 50/60 U.S. Mesh and 120/140 U.S. Mesh and provide a grit product for testing. The test involved making respective grinding wheels by electroplating the cBN grit at a single layer onto wheels and using the grinding wheels to grind a workpiece comprising spheroidal graphite iron (SGI). More specifically, the grade of workpiece material chosen was GGG70 (or EN GJS 700-2), which is a strong, pearlitic SGI, typical of those used in automotive components such as crank and cam shafts.

TABLE 2

| | | | | | Example |
|---|---|---|---|---|---|
| | | | | | cBN friatest |
| Size | | | Reference | Example | result |
| band, | | Number | cBN friatest | cBN friatest | after heat |
| US | Ball | of | result, | result, | treatment, |
| Mesh | diameter | cycles | wt. % | wt. % | wt. % |
| 30/35 | ¼″ | 500 | Not | 50.0 | 10.0 |
| | | | measured | | |
| 35/40 | ¼″ | 500 | Not | 60.9 | 22.0 |
| | | | measured | | |
| 40/45 | ¼″ | 1000 | Not | 48.4 | 15.5 |
| | | | measured | | |
| 45/50 | ¼″ | 1000 | Not | 56.0 | 26.0 |
| | | | measured | | |
| 50/60 | ¼″ | 1000 | 68 | 64.8 | 42.0 |
| 60/70 | 5/16″ | 1000 | Not | 59.4 | 34.2 |
| | | | measured | | |
| 70/80 | 5/16″ | 1000 | Not | 65.0 | 43.0 |
| | | | measured | | |
| 80/100 | 5/16″ | 1000 | Not | 70.7 | 54.3 |
| | | | measured | | |
| 100/120 | 5/16″ | 2000 | Not | 54.0 | 37.5 |
| | | | measured | | |
| 120/140 | 5/16″ | 2000 | 67 | 59.0 | 48.0 |
| 140/170 | 5/16″ | 2000 | Not | 63.0 | 54.0 |
| | | | measured | | |
| 170/200 | 5/16″ | 2000 | Not | 63.2 | 59.3 |
| | | | measured | | |

The wheels were nickel electroplated 1A1 and had dimensions 250 mm×10 mm×127 mm. As the grinding wheels were 10 mm wide, but only 5 mm was used at a time for each of the two tests, both the window of operation and tool-life tests could be completed using one wheel by employing a step grinding setup. The mode of grinding was up-grinding which provides a more effective supply of coolant to the cutting zone. The wheels were clocked onto the spindle and balanced to an eccentricity of at least 0.5 micron using a Best Balance™ 1000 portable balancing system. As the tools were single-layer, electroplated wheels, no dressing was carried out. The tests were carried out on a Blohm Profimat MT408™ with a Frans Kessler™ 45 kW spindle motor with a maximum speed of 8300RPM. Coolant fluid was supplied at 9 bar using a Brinkmann™ impeller pump and a Brinkmann™ screw pump was used to deliver coolant at 40 bar to a cleaning nozzle. The coolant used was mains water with 4% Metlube 3™. The grinding forces were measured using a Kistler™ dynamometer and logged on LabView™ data acquisition software.

The grinding conditions for both the window-of-operation and tool-life tests are listed in table 3. It should be noted that the increased forces generated by the finer abrasives limited the specific material removal rate used in the tool-life test to 75 mm³/mm/s and to a maximum of 220 mm³/mm/s in the window-of-operation test.

TABLE 3

| | US mesh size | |
|---|---|---|
| Parameter | 50/60 | 120/140 |
| Wheel speed, m/s | 100 | 100 |
| Workpiece speed (window of | 100-26,400 | 100-13,200 |
| operation), mm/min | | |
| Specific material removal | 1.67-440 | 1.67-220 |
| rate (window of operation), | | |
| mm³/mm/s | | |
| Workpiece speed (tool-life), | 6,000 | 4,500 |
| mm/min | | |
| Specific material removal | 100 | 75 |
| rate (tool-life), mm³/mm/s | | |
| Depth of cut, mm | 1 | 1 |
| Coolant | Mains water with | Mains water with |
| | 4% Metlube 3 | 4% Metlube 3 |
| Wheel type | 1A1, | 1A1, |
| | 250 × 10 × 127 mm | 250 × 10 × 127 mm |
| Workpiece | GGG70 | GGG70 |
| | (EN GJS 700-2) | (EN GJS 700-2) |

As shown in FIG. 3, the specific normal and tangential grinding forces F′ₙ and F′ₜ generated in the window-of-operation test varied substantially linearly with material removal rate Q′_{w}, both for the example cBN grit and commercially available reference grit. As shown in FIG. 4, the forces generated by the example cBN grit in the window-of-operation test was substantially different for the 50/60 grit and the 120/140 grit, the latter generating substantially higher grinding forces for the same material removal rate, as may be expected. The grinding forces generated by a single layer tool are expected generally to increase as the volume of workpiece ground increases, possibly because the grinding forces increase rapidly as the sharp and protruding fresh grains wear, before levelling off. Then, depending on the abrasive product and application, the end-of-life can be reached with the grinding forces rising steadily through-out the test, or by a sudden increase caused by the breakdown of the abrasive particles.

The grinding power P for a particular application can be monitored directly from the power supply to the spindle or calculated from the tangential grinding force Fₜ and the wheel speed vₛ, according to the equation P=Fₜ vₛ. The specific energy u is a useful measure of the grinding efficiency of a tool and can be calculated from the grinding power P and material removal rate Q_{w}. The specific energy values for a range of material removal rates are plotted in FIG. 4.

The specific energy values for the example cBN grit E and the reference cBN grit product R, both in sizes 50/60 and 120/140, across a range of material removal rates are plotted in FIG. 5. The difference in grinding efficiency between the two products E and R seems to be minimal, particularly above 100 mm³/mm/s, but the effect of particle size is significant.

The end-of-life criterion for the test grinding wheels was deemed to be when a specific normal grinding force of 90 N/mm was reached. FIG. 6 shows the specific normal force F′ₙ up to the deemed end-of-life as a function of specific volume V′ of material removed by the example cBN grit E and reference cBN grit R in the size range 120/140 U.S. Mesh. FIG. 7A shows comparative specific volumes V′ removed by the wheels comprising the example cBN grit E and the reference cBN grit R in the US Mesh size range 50/60, corresponding to specific normal grinding forces F′ₙ of 70 N/mm, 80 N/mm and 90 N/mm. FIG. 7B shows this data in the case of the grit in US Mesh size range 120/140. In this test, the grinding wheel comprising the example cBN grit in the 50/60 US Mesh size range had an effective working life of about 37 percent longer than that of the reference cBN grit in the same size range, and the example cBN grit in the 120/140 US Mesh size range had an effective working life of about 57 percent longer than that of the reference cBN grit in the same size range. The force ratio μ is an indicator of the condition of the abrasive and is readily calculated from the normal Fₙ and tangential force Fₜ components. A value of 0.2 or less corresponds to a well-lubricated blunt grit with little surface penetration, whereas high values correspond to sharp grains and deep penetration into the work-piece. The force ratio values generally trended downwards as the tool-life test progressed, confirming that the abrasive particles were wearing and becoming blunter. The results plotted in FIG. 8A and FIG. 8B also indicate that the example cBN grit consistently remained sharp for a relatively longer than the reference cBN grit. in this test.

The roughness of the workpiece surfaces both parallel and perpendicular to the grinding direction was measured at intervals throughout the tool-life test of the grinding wheels comprising the example and the reference cBN grit in the 50/60 US Mesh size ranges. FIG. 9 shows the Rₐ and R_{z} results in the perpendicular direction, which exhibits higher roughness values than the parallel direction. Generally, the roughness values trended downwards i.e. the surface quality improved, as the tool-life test progressed. This is typical for grinding wheels due to the grits wearing and becoming blunter, which generates higher grinding forces but a better surface finish.

Inspection and comparison of the grinding wheels after the test revealed that a substantially higher fraction of the reference cBN grit had been pulled out of the electroplated bond than had the example cBN grit. This was evident from the fraction of empty pockets in the wheel in which cBN crystals had been bonded. In the case of the wheel comprising grit in the 50/60 US Mesh size range, approximately twice the number of reference cBN crystals had been pulled out of the bond than the number of example cBN crystals.

In the tool-life test, the example cBN grit lasted relatively longer than the reference cBN grit when grinding ductile cast iron. The example cBN grit exhibited superior performance in the test, which may be due to the combination of high strength and the crystal breakdown characteristics. The force ratio results indicated that the grit consistently remained sharp for relatively long time in the test. The crystals generally have a rough appearance and exhibit relatively low levels of pull-out from the bond and relatively few cleaved particles.

Although increased surface quality is normally associated with blunt particles and higher grinding forces, the example cBN grit consistently generated lower surface roughness than the reference cBN grit. This could be due to the micro-fracturing characteristics of the crystals producing a number of sharp cutting points per grain during breakdown. The example cBN grit exhibited a longer tool life than the reference cBN grit when grinding ductile cast iron, and remained relatively sharp throughout testing while generating a smooth surface finish comparable to that produced by substantially weaker cBN grit products.

The combination of particle strength and breakdown characteristics seems to have a significant effect on the performance of single layer tools. Under similar conditions, single layer cBN grinding wheels containing coarser abrasives were found to generate lower grinding forces and exhibit a lower specific grinding energy than the same product in a finer size. When grinding with single layer cBN electroplated tools at constant conditions, the grinding forces were found to increase and the force ratio and surface roughness decrease, as the volume of material removed increased.

The hardness, strength and thermal conductivity of the cBN abrasive are believed to play a key role in grinding operations in achieving higher material removal rates while reducing heat transfer into the workpiece. Grinding wheel speeds of over 100 m/s make specific material removal rates in excess of 1,000 mm³/mm/s possible but place large stresses on machines and tools. Single layer electroplated grinding wheels are used in these applications as they can withstand the high centrifugal forces generated by these wheel speeds. Electroplated wheels also enable the production of grinding wheels with intricate profiles cheaply and can dispense with the additional complication of dressing before use. High-speed grinding of steel and iron crank shafts with electroplated cBN wheels may benefit from the potential productivity gains from using high material removal rates when machining these high-volume components. cBN products used in these extreme applications must have the toughness and strength to withstand the stresses placed upon them, but also desirable breakdown characteristics which allow them to micro-fracture and retain sharp cutting edges. Weak abrasives which micro-fracture too easily or strong macro-fracturing abrasives can lead to the loss of part or all of a particle prematurely, resulting in a reduction in the life of the tool.

1. A cubic boron nitride (cBN) crystal containing a chloride salt compound including an alkali metal or an alkali earth metal.

2. A cBN crystal as claimed in claim 1, in which the content of alkali or alkali earth metal is at least 10 parts per million (ppm) and at most 100,000 ppm of the cBN crystal.

3. A cBN crystal as claimed in claim 1, in which the chloride salt compound is selected from potassium chloride, magnesium chloride, lithium chloride, calcium chloride or sodium chloride.

4. A cBN crystal as claimed in claim 1, in which the chloride salt compound is selected from potassium chloride or magnesium chloride.

5. A cBN crystal as claimed in claim 1, containing B₂O₃.

6. A cBN crystal as claimed in claim 1, being free of compounds including titanium.

7. A cBN crystal as claimed in claim 1, in which the chloride salt compound is present in inclusions dispersed within the cBN crystal.

8. A cBN crystal as claimed in claim 1, in which the chloride salt is present as dispersed inclusions having a mean size of at most 4 microns.

9. A cBN crystal as claimed in claim 1, within a U.S. Mesh size band of 30/50 and containing at least 5 and at most 20 inclusions.

10. A cBN crystal as claimed in claim 1, containing inclusions at least half of which are elongate, having an aspect ratio of at least 1.5.

11. A cBN crystal as claimed in claim 1, containing inclusions each of which has a volume of at least 300 cubic microns and at most 60,000 cubic microns.

12. A cBN crystal as claimed in claim 1, containing inclusions at least half of which have a volume of at most 10,000 cubic microns.

13. A cBN crystal as claimed in claim 1, containing inclusions the density of each of which is at least 0.5 gram per cubic centimeter and at most 3 grams per cubic centimeter.

14. A cBN crystal as claimed in claim 1, having a crystal habit corresponding to a cubo-octahedral index of at least 5 and a tetrahedral index of at least 2.

15. A cBN crystal as claimed in claim 1, the surface roughness of which is such that each crystal has at least 80 surface faces per square millimeter of the crystal surface, each face having an area of at least 500 square microns.

16. A plurality of cBN crystals as claimed in claim 1, the strength of the cBN crystals in terms of friability being at least 50 per cent.

17. A plurality of cBN crystals as claimed in claim 16, each crystal being in the U.S. Mesh size band of 50/60, the strength of the cBN crystals in terms of friability being at least 60 per cent.

18. A plurality of cBN crystals as claimed in claim 16, each crystal being within a U.S. Mesh size band of 30/50 and the plurality of crystals having a mean number of at least 5 and at most 20 inclusions.

19. A plurality of cBN crystals as claimed in claim 16, containing inclusions, the mean volume of each of which is at least 300 cubic microns and at most 20,000 cubic microns.

20. A method of making a cBN crystal as claimed in claim 1, the method including combining a source of boron nitride, a catalyst material for promoting the growth of cBN crystals and a source of chlorine in a reaction volume, and subjecting the reaction volume to a pressure and temperature in the presence of a source of an alkali metal or an alkali earth metal, at which pressure and temperature cBN is more thermally stable than hBN, to form a cBN crystal.

21. A method as claimed in claim 20, including providing the cBN crystal with a coating comprising Ti, Ni and or W.

22. A body comprising polycrystalline cBN material (PCBN) comprising a plurality of cBN crystals, each as claimed in claim 1.

23. A tool comprising a plurality of cBN crystals as claimed in claim 1.

24. A tool as claimed in claim 23, selected from a grinding wheel, cutting tool, saw blade or bead for a wire saw.

25. A tool as claimed in claim 23, in which the cBN crystals are bonded to a tool body by means of an electroplated bond.

26. A cBN crystal as claimed in claim 8, containing inclusions the density of each of which is at least 0.5 gram per cubic centimeter and at most 3 grams per cubic centimeter.

27. A cBN crystal as claimed in claim 8, the surface roughness of which is such that each crystal has at least 80 surface faces per square millimeter of the crystal surface, each face having an area of at least 500 square microns.

28. A method of making a cBN crystal as claimed in claim 8, the method including combining a source of boron nitride, a catalyst material for promoting the growth of cBN crystals and a source of chlorine in a reaction volume, and subjecting the reaction volume to a pressure and temperature in the presence of a source of an alkali metal or an alkali earth metal, at which pressure and temperature cBN is more thermally stable than hBN, to form a cBN crystal.

29. A cubic boron nitride (cBN) crystal containing a chloride salt compound including an alkali metal or an alkali earth metal, in which the chloride salt is present as dispersed inclusions having a mean size of at most 4 microns; the surface roughness of the cBN crystal being such that it has at least 80 surface faces per square millimeter of the crystal surface, each face having an area of at least 500 square microns.
